(19) United States
(12) Patent Application Publication
(10) Pub. No.: US 2012/0275262 A1
(43) Pub. Date: Nov. 1, 2012

(54) SECTION-ILLUMINATION PHOTOACOUSTIC MICROSCOPY WITH ULTRASONIC ARRAY DETECTION

(75) Inventors: Liang Song, St. Louis, MO (US); Lihong Wang, St. Louis, MO (US); Konstantin Maslov, St. Louis, MO (US)

(73) Assignee: WASHINGTON UNIVERSITY, St. Louis, MO (US)

(21) Appl. No.: 13/450,793

(22) Filed: Apr. 19, 2012

Related U.S. Application Data
(60) Provisional application No. 61/480,577, filed on Apr. 29, 2011.

(51) Int. Cl. G03B 42/06

(52) U.S. Cl. 367/7

(57) ABSTRACT

Imaging systems, probes for imaging systems, and methods for noninvasive imaging are disclosed. In one example, a probe for use with an imaging system includes a slit configured to spatially filter a light beam from a light source. The probe includes a focusing device configured to cylindrically focus the spatially filtered light beam into an object, and an ultrasound transducer array configured to detect a photoacoustic signal emitted by the object in response to the cylindrically focused light beam.

### CROSS-REFERENCE TO RELATED APPLICATION

This application claims priority to U.S. Provisional Application No. 61/480,577 filed Apr. 29, 2011, the entire disclosure of which is hereby incorporated by reference in its entirety.

### STATEMENT REGARDING FEDERALLY SPONSORED RESEARCH & DEVELOPMENT

This invention was made with government support under grants R01 EB000712 and U54 CA136398, both awarded by the U.S. National Institutes of Health. The government has certain rights in the invention.

### BACKGROUND

The ability to image microstructures, such as the micro-vascular network in the skin or brain cortex, and to monitor physiological functions of tissue is invaluable. One of the promising technologies for accomplishing this objective is photoacoustic microscopy. Current high-resolution optical imaging techniques, such as optical coherence tomography, can image up to approximately one transport mean free path (about 1 to 2 mm) into biological tissue. These techniques are sensitive to backscattering, which is related to tissue morphology, but they are insensitive to optical absorption that is related to important biochemical information. Other well-known techniques, such as confocal microscopy and multi-photon microscopy, have even more restrictive penetration depth limitations and often involve the introduction of exogenous dyes, which with a few notable exceptions have relatively high toxicity. Acoustic microscopic imaging and spectroscopy systems are sensitive to acoustic impedance variations, which provide little functional information about biological tissue and have low contrast in soft tissue. Other imaging techniques, such as diffuse optical tomography, have low depth to resolution ratios. Photoacoustic imaging provides high optical-absorption contrast while maintaining high penetration depth and high ultrasonic resolution. Moreover, because photoacoustic wave magnitude is, within certain bounds, linearly proportional to the optical contrast, optical spectral measurement can be performed to gain functional (physiological) information such as the local blood oxygenation level.

### BRIEF DESCRIPTION

In one aspect, a probe for use with an imaging system includes a slit configured to spatially filter a light beam from a light source. The probe includes a focusing device configured to cylindrically focus the spatially filtered light beam into an object, and an ultrasound transducer array configured to detect a photoacoustic signal emitted by the object in response to the cylindrically focused light beam.

In another aspect, an imaging system includes a light source configured to emit a light beam, and a probe. The probe includes a slit configured to spatially filter a light beam from a light source, a focusing device configured to cylindrically focus the spatially filtered light beam into an object, and an ultrasound transducer array configured to detect a photoacoustic signal emitted by the object in response to the cylindrically focused light beam.

In yet another aspect, a method for noninvasive imaging is disclosed. The method includes cylindrically focusing at least one light pulse into a portion of an object, receiving a photoacoustic signal emitted by the object in response to the cylindrically focused light pulse, and generating an image of the portion of the object based, at least in part, on the received photoacoustic signal.

### BRIEF DESCRIPTION OF THE DRAWINGS

The embodiments described herein may be better understood by referring to the following description in conjunction with the accompanying drawings.

FIG. 1 is a diagram of the photoacoustic probe of an imaging system in accordance with one embodiment of the present disclosure, including a beam combining element for directing a reflected photoacoustic signal to a transducer array.

FIG. 2 is a block diagram showing the overarching architecture of the present disclosure

FIG. 3 is a diagram of an integrated focusing assembly of a reflection mode imaging system in accordance with another embodiment of the present disclosure, including an optically transparent acoustic reflector to merge optical delivery and ultrasonic detection coaxially.

FIG. 4 is a diagram of an integrated focusing assembly of a reflection mode imaging system in accordance with yet another embodiment of the present disclosure including an acoustically transparent optical reflector to merge optical delivery and ultrasonic detection coaxially.

FIG. 5 is a diagram of an integrated focusing assembly of a reflection mode imaging system in accordance with yet another embodiment of the present disclosure including an optical delivery path through an aperture in an ultrasonic transducer array.

FIG. 6 is a diagram of an integrated focusing assembly of a transmission mode imaging system in accordance with the still another embodiment of the present disclosure.

FIGS. 7A and 7B shows photoacoustic images of two crossed 6-micrometer diameter carbon fibers acquired with a prototype of the assembly in FIG. 6.

FIG. 7C is a graph of photoacoustic amplitude from the carbon fiber along the dashed line in FIG. 7B.

FIG. 7D is an MAP image of a 250 micrometer needle inserted in a pork specimen acquired with the prototype of the assembly in FIG. 6 at 584 nm.

FIGS. 7E and 7F are in vivo photoacoustic images of a mouse ear vasculature acquired with the prototype of the assembly in FIG. 6.

FIG. 8 shows snapshots from in vivo monitoring of the wash in dynamics of Evans Blue dye in mouse ear microcirculation, acquired with the prototype of the integrated focusing assembly of FIG. 6.

FIG. 9A is a MAP image of mouse ear microcirculation, acquired with the prototype of the integrated focusing assembly of FIG. 6 at 584 nm.

FIG. 9B and 9C are B-scan images of mouse ear microcirculation, acquired with the prototype of the integrated focusing assembly of FIG. 6 at 584 nm and 600 nm, respectively.

FIG. 9D is a graph of the photoacoustic amplitude representing Evans Blue dye concentration in mouse ear microcirculation as a function of time.

FIG. 10 is a flowchart illustrating an exemplary imaging method.

### DETAILED DESCRIPTION

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the disclosure and do not delimit the scope of the disclosure.

To facilitate the understanding of this disclosure, a number of terms are defined below. Terms defined herein have meanings as commonly understood by a person of ordinary skill in the areas relevant to the present disclosure. Terms such as “a,” “an” and “the” are not intended to refer to only a singular entity, but include the general class of which a specific example may be used for illustration. The terminology herein is used to describe specific embodiments of the disclosure, but their usage does not delimit the disclosure, except as outlined in the claims.

To be consistent with the commonly used terminology, whenever possible, the terms used herein will follow the definitions recommended by the Optical Society of America (OCIS codes).

In some embodiments, the term “photoacoustic microscopy” refers to a photoacoustic imaging technology that detects pressure waves generated by light absorption in the volume of a material (such as biological tissue) and propagated to the surface of the material. In other words, photoacoustic microscopy is a method for obtaining images of the optical contrast of a material by detecting acoustic or pressure waves traveling from the object. As used herein, the term “photoacoustic microscopy” includes detection of the pressure waves that are still within the object.

In some embodiments, the terms “reflection mode” and “transmission mode” refer to a laser photoacoustic microscopy system that employs the detection of acoustic or pressure waves transmitted from the volume of their generation to the optically irradiated surface and a surface that is opposite to, or substantially different from, the irradiated surface, respectively.

In some embodiments, the term “ultrasound array” refers to an array of ultrasonic transducers.

In some embodiments, the term “diffraction limited resolution” refers to the best possible resolution by focusing light within the limitations imposed by diffraction.

In some embodiments, the term “photoacoustic emissions” refers to the pressure waves produced by light absorption.

In some embodiments, the term “B-scan image” refers to a cross-sectional two-dimensional image in the plane containing the acoustic axis.

In some embodiments, the term “integrated focusing assembly” refers to an integrated assembly including optical focusing components, an ultrasound array, and the coupling devices between them.

In some embodiments, the term “photoacoustic beamforming” refers to a signal processing technique used to reconstruct a photoacoustic B-scan image from received signals.

Embodiments of the present disclosure provide methods, systems, and apparatus for high-speed three-dimensional photoacoustic imaging using section illumination in conjunction with ultrasound array detection. Specifically, embodiments of the present disclosure use a cylindrically focused laser beam (i.e., section illumination) to produce a rapid local temperature rise due to absorption of the pulsed light. The temperature rise leads to a transient thermal expansion, resulting in photoacoustic emission, which is detected by a high-frequency ultrasound array to reconstruct an image. The image signal amplitude is related to the optical absorption and Grueneisen coefficients. While the section illumination excites photoacoustic waves over a plane, the ultrasound array detects them simultaneously. As a result, embodiments of the present disclosure may improve the imaging speed of photoacoustic microscopy. In addition, the section illumination enables optical diffraction limited elevational resolution as determined by the thickness of the illumination plane and reduces the background, which may lead to a quality improvement in three-dimensional imaging. Overall, embodiments of the present disclosure provide photoacoustic imaging of optical absorption contrast with high spatial resolution at high speed.

One example embodiment of the present disclosure employs a tunable dye laser pumped by an Nd:YLF laser as the irradiation source. In this embodiment, the laser pulse duration is 7 ns and the pulse repetition rate, which is controlled by the external triggering signal, can be as high as 1.5 kHz without significant degradation of the output energy. In other embodiments, a plurality of sources of penetrating radiation, which can be confined to or concentrated in a small volume within the object, may be used. Such sources include, but are not limited to, pulsed lasers, flash lamps, other pulsed electromagnetic sources, particle beams, or their intensity-modulated continuous-wave counterparts. The present disclosure includes any realization of light focusing using any kind of mirrors, lenses, fibers, and/or diaphragms that can produce cylindrically focused illumination confined to the field of view of an ultrasound array.

To provide section illumination for photoacoustic excitation, an example embodiment of the present disclosure uses a cylindrical lens with a numerical aperture of about 0.015; for photoacoustic signal detection, it uses a 30-MHz linear ultrasound array. In scattering biological tissue, the system can image about 1 5 mm deep with axial, elevational, and lateral resolutions of 25, 28, and 70 micrometers, respectively. The system uses electronic beamforming for B-scan imaging, and requires only 1D linear scanning for 3D imaging, offering B-scan and 3D imaging at 249 Hz and 0.5 Hz, respectively, which may be two orders of magnitude faster than some known examples of single element based photoacoustic microscopy.

The imaging procedure described herein is one of the possible embodiments specifically aimed at medical and biological applications. The optical absorption contrast of the present disclosure is complementary to the structural information that can be obtained from purely optical or ultrasonic imaging technologies, and can be used for diagnostic, monitoring, or research purposes. Some applications of the technology include, but are not limited to, the imaging of arteries, veins, and pigmented tumors (such as melanomas) in vivo in humans or animals. Embodiments of the present disclosure can use the spectral properties of intrinsic optical contrast to monitor blood oxygenation, blood volume (total hemoglobin concentration), and even the metabolic rate of oxygen. Embodiments of the present disclosure can also use the spectral properties of a variety of dyes or other contrast agents to obtain additional functional or molecular-specific information. In short, embodiments of the present disclosure are capable of functional and molecular imaging. In addition, embodiments of the present disclosure can be used to monitor possible tissue changes during x-ray radiation therapy, chemotherapy, or other treatment. Embodiments of the present disclosure can also be used to monitor topical application of cosmetics, skin creams, sun-blocks, or other skin treatment products. Moreover, the high imaging speed of the present disclosure may be beneficial for clinical practice because it may reduce motion artifacts, patient discomfort, cost, and risks associated with minimally invasive procedures such as endoscopy.

To translate photoacoustic imaging into clinical practice, a high imaging speed is needed to reduce motion artifacts, cost, patient discomfort, and most important, the risks associated with minimally invasive procedures (e.g., endoscopy). Embodiments described herein provide the combined use of an ultrasound array and a high-repetition laser system can help photoacoustic imaging meet the challenges of clinical translation. In addition, embodiments of the present disclosure use section illumination to provide optical diffraction limited elevational resolution and reduced background, which are difficult to achieve using ultrasonic approaches. Therefore, embodiments of the present disclosure offer methods, apparatus, and systems of photoacoustic imaging with high imaging speed and spatial resolution sufficient for many clinical and preclinical applications.

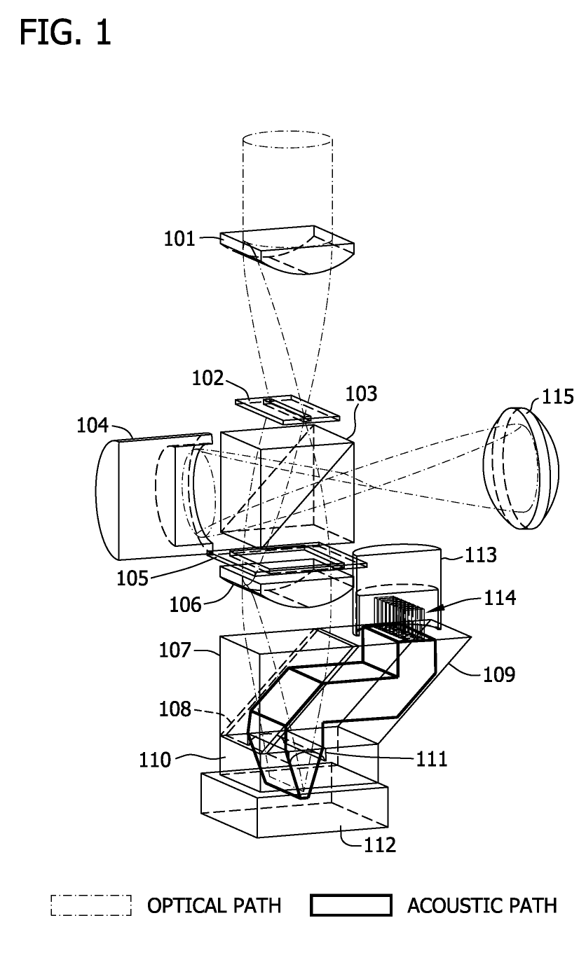

FIG. 1 is a schematic of the photoacoustic probe of an imaging system in accordance with one embodiment of the present disclosure. The light from a wavelength tunable laser is focused by a cylindrical lens 101 onto a slit 102 for spatial filtering. While a photo-detector 104 is used to monitor the laser pulse energy through a sampling beam splitter 103, an eyepiece 115 is used to optically image the object's surface for alignment. To provide section illumination for photoacoustic excitation, the light coming from the slit is focused by another cylindrical lens 106 into an imaging object 112 through an aperture 105 and a beam combining element 107, 108, 109. Thus, the beam of laser light is first expanded and then cylindrically focused into the imaging object. The beam combining element mainly consists of an isosceles triangular prism 107 and a rhomboidal prism 109 (the two prisms are adjoined along the diagonal surfaces with a gap of 0.1 mm in between). The gap is filled with an optical refractive-index-matching, low-acoustic-impedance, nonvolatile liquid 108 (e.g., 1000 cSt silicone oil). The silicone oil and the glass have a good optical refractive index match (glass: 1.5; silicone oil: 1.4) but a large acoustic impedance mismatch (glass: 12.1×10⁶ N·s/m³; silicone oil: 0.95×10⁶ N·s/m³). As a result, the silicone oil layer is optically transparent but acoustically reflective. The photoacoustic signal emitted by the object is slightly focused by a cylindrical acoustic lens 111 and then detected by an ultrasound array transducer 113,114 through an acoustic coupling medium 110 (e.g., ultrasound coupling gel). Within the bandwidth of the ultrasound array, ultrasonic absorption in the silicone oil is high enough to dampen acoustic reverberations in the matching layer and thus minimize interference with the image.

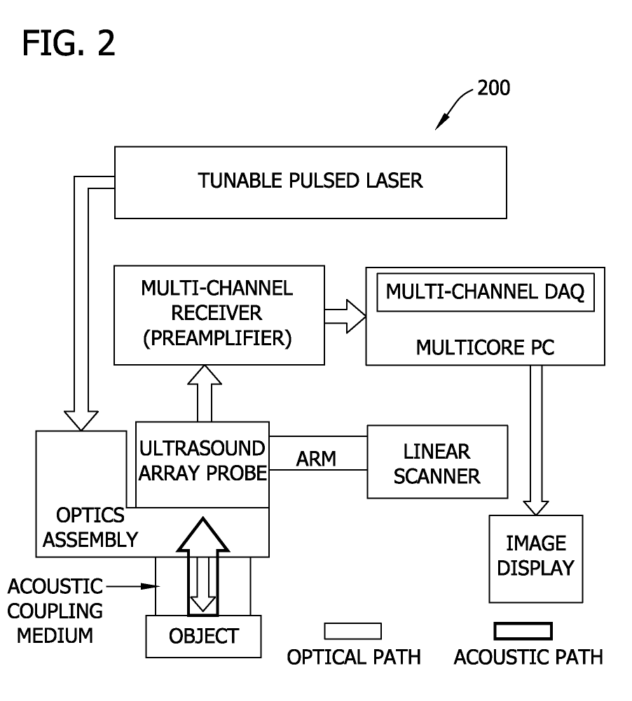

FIG. 2 is a block diagram showing the overarching architecture of a photoacoustic system 200 the present disclosure. Components of system 200 include a high-repetition-rate pulsed tunable laser system, an optical focusing assembly, an ultrasound array, a high-speed multi-channel data acquisition (DAQ) subsystem, a linear scanner, and a multi-core computer. The optical focusing assembly receives pulsed laser light and provides section illumination for photoacoustic excitation. The data acquisition system records and digitizes the received photoacoustic signal. The laser pulse generation, data acquisition, and mechanical scanning of the ultrasound array are synchronized using triggering signals from the data acquisition card. To optimize the data acquisition and imaging speed, the number of data acquisition channels should match the number of elements of the ultrasound array. However, when the number of array elements is greater, multiplexers may be used. An off-the-shelf multi-core personal computer, together with a parallel computing program based on Microsoft Visual Studio or other software development tools, is used to perform photoacoustic beamforming for real-time imaging and display.

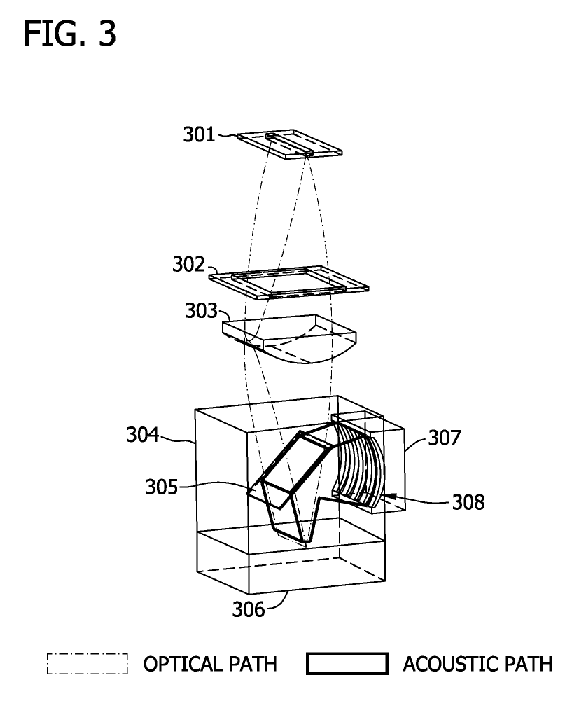

To integrate the optical focusing and the ultrasonic detection for the present disclosure, one or more of the following devices or designs can be used: (1) an optically transparent acoustic reflector, (2) an acoustically transparent optical reflector, (3) a custom-made opening through the ultrasound array, or (4) direct integration in transmission mode. Examples of the integrated focusing assembly are described with reference to FIGS. 3-6, wherein the integrated focusing assembly includes optical focusing components, an ultrasound array, and the coupling devices between them. Note that supporting components (such as the aligning optics and the laser output power monitoring devices) are not shown in FIGS. 3-6.

FIG. 3 shows the integrated focusing assembly of an imaging system in accordance with another embodiment of the present disclosure. An optically transparent acoustic reflector 305 (e.g., a sapphire plate) is used to merge the optical delivery and the ultrasonic detection coaxially. The laser light coming from a slit 301 and an aperture 302 is focused into an imaging object 306 by a cylindrical lens 303. Through an acoustic coupling medium 304 and the acoustic reflector 305, the photoacoustic signal emitted from the object is detected by an ultrasound array 307,308.

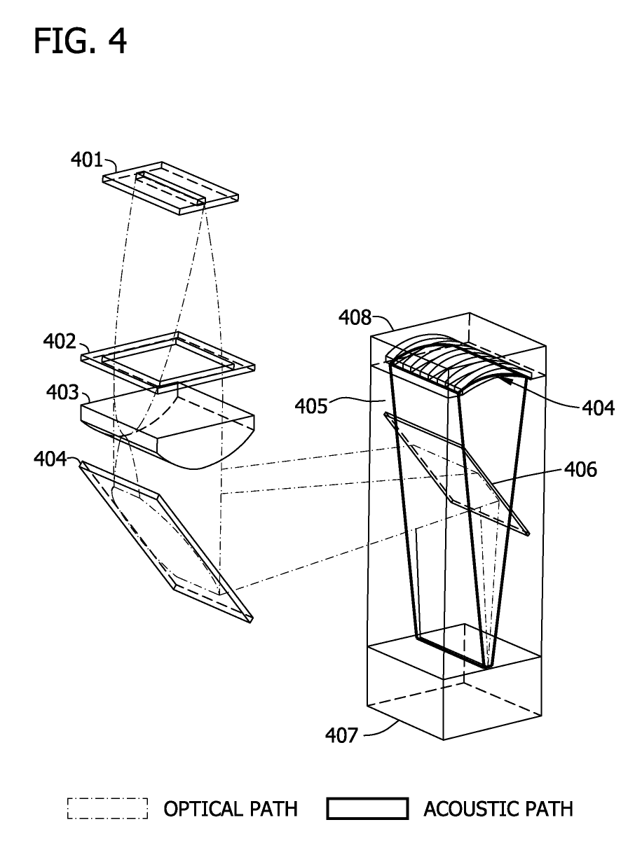

FIG. 4 shows the integrated focusing assembly of an imaging system in accordance with yet another embodiment of the present disclosure. An acoustically transparent optical reflector 406 (e.g., an aluminized thin film) is used to merge the optical delivery and the ultrasonic detection coaxially. The laser light coming from a slit 401 and an aperture 402 is focused by a cylindrical lens 403, and directed into an imaging object 407 by a dielectric mirror 404 and the optical reflector 406. Passing through an acoustic coupling medium 405 and the acoustically transparent thin film 406, the photoacoustic signal emitted from the object is detected by an ultrasound array 408, 409. In addition to the acoustically transparent optical reflector, a prism or other types of optical reflectors whose dimensions are much smaller than the acoustic receiving volume can also be used to merge the optical delivery and the ultrasonic detection coaxially. This embodiment may be particularly suitable for integration with commercially available ultrasound array transducers, for example, the high-frequency linear arrays used with the some imaging systems.

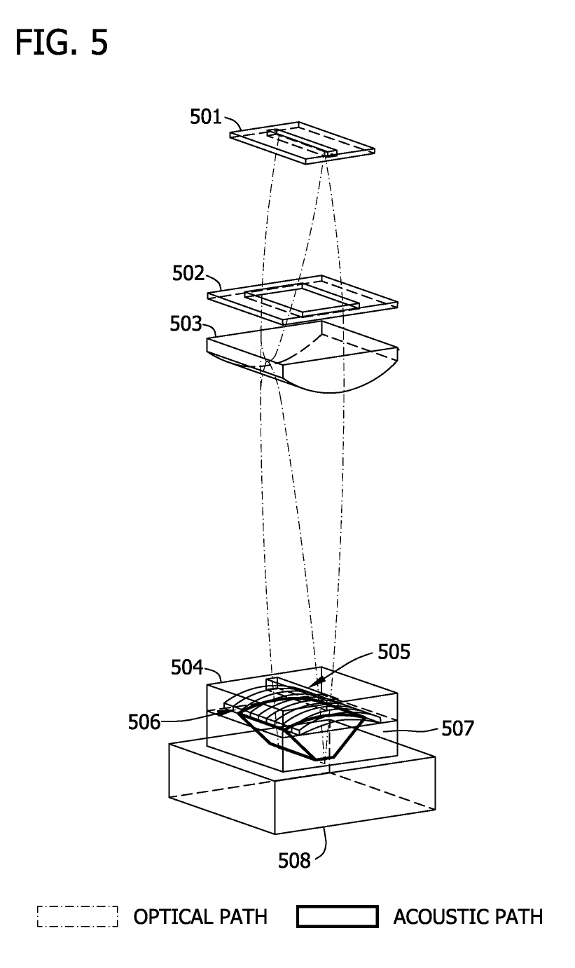

FIG. 5 shows the integrated focusing assembly of an imaging system in accordance with yet another embodiment of the present disclosure. The laser light coming from a slit 501 and an aperture 502 is focused by a cylindrical lens 503 into an imaging object 508. While a custom-made slot opening 505 in an ultrasound array 504, 506 allows the focused laser light to pass through the array, its small dimension has little impact on ultrasound reception. As a result, through a coupling medium 507, the photoacoustic signal emitted from the object is detected well by the ultrasound array.

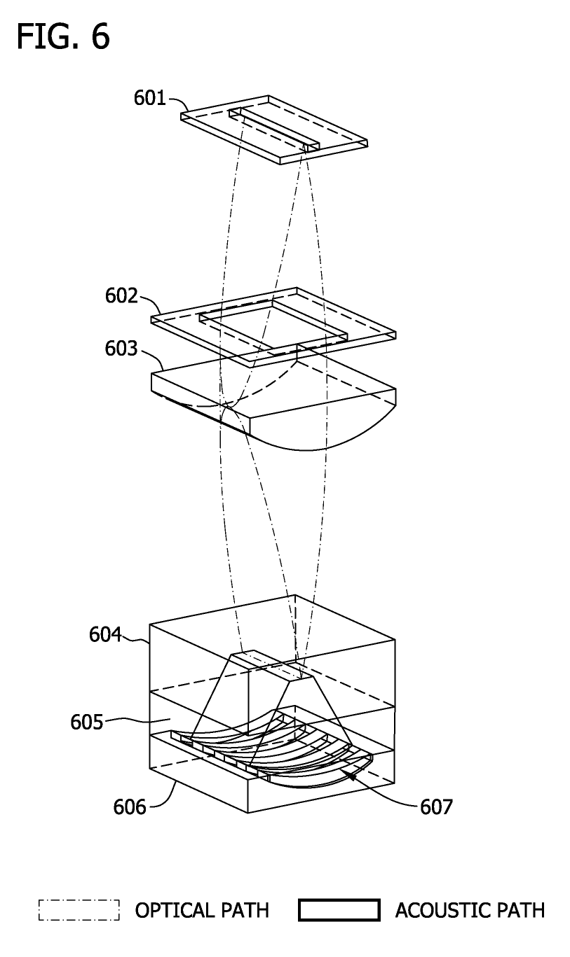

FIG. 6 shows the integrated focusing assembly of an imaging system in accordance with yet another embodiment of the present disclosure. A transmission-mode design is used to merge the optical delivery and the ultrasonic detection coaxially. The laser light coming from a slit 601 and an aperture 602 is focused by a cylindrical lens 603 into an imaging object 604. From the other side of the object, after passing through a coupling medium 605, the photoacoustic signal emitted from the object is detected by the ultrasound array 606, 607. Coordinates x, y, and z represent the lateral, elevational, and axial (depth) directions of the ultrasound array 606, 607, respectively.

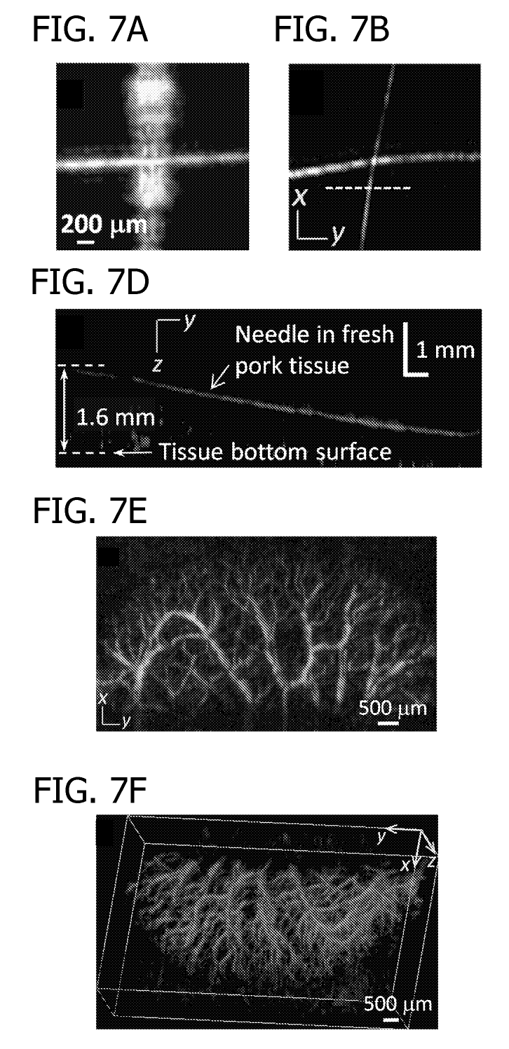

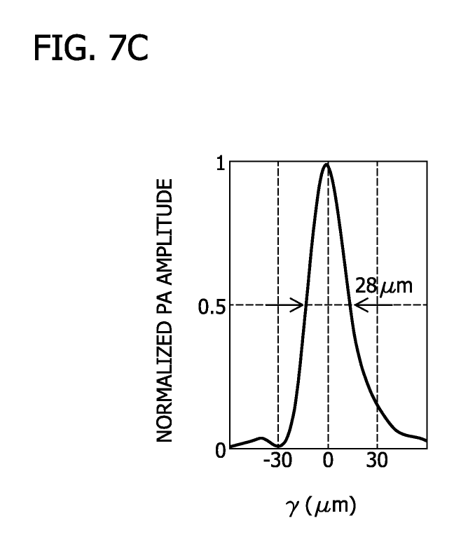

The above-described embodiments have been successfully demonstrated for biomedical applications. FIG. 6 illustrates a system prototype based on the transmission mode design, and using multi-focus 1D array illumination in conjunction with linear ultrasonic array detection. The system prototype was used to acquire the images shown in FIGS. 7A-9D. The prototype system employs a tunable dye laser pumped by an Nd:YLF laser as the irradiation source. The laser pulse duration is approximately 7 nanoseconds (ns), and the pulse repetition rate may be as high as 1.5 kHz without significant degradation of the output energy. For photoacoustic excitation, a cylindrical lens with a numerical aperture of about 0.015 to provide section illumination is used. The slit 601 has width of approximately 50 micrometers and the aperture 602 has a width of approximately 5 millimeters. For photoacoustic signal detection, a 30-MHz linear ultrasound array consisting of 48 elements with a spacing of about 100 micrometers is used. In scattering biological tissue, the prototype system images approximately 1.6 mm deep, with axial, elevational, and lateral resolutions of 25, 28, and 70 micrometers, respectively. The prototype system is capable of 249 Hz B-scanning and 0.5 Hz 3D scanning, which is one to two orders of magnitude faster than some known mechanical scanning single element photoacoustic microscopy. With an increased laser pulse repetition rate (without degradation of output energy per pulse), and a 48-channel data acquisition system to eliminate the multiplexing the imaging speed may be further improved. In addition, the electronic beamforming in this prototype system eradicates tiny vibrations that might be introduced by mechanical scanning during a B-scan in single element photoacoustic microscopy. Furthermore, the 28-micrometer optically defined elevational resolution is more than 10-fold better than the acoustically defined counterpart, which may lead to a significant improvement in the overall image quality.

FIGS. 7A and 7B show photoacoustic maximum amplitude projection (MAP) images of two crossed 6-micrometer diameter carbon fibers acquired at 584 nm, without and with section illumination. MAP refers to the maximum photoacoustic amplitudes projected along a direction—usually the depth or z axis direction unless otherwise mentioned—to its orthogonal plane. With section illumination, the elevational resolution is improved approximately 13-fold from approximately 400 to approximately 28 micrometers, as shown in FIG. 7C, while the in-plane lateral resolution (approximately 70 micrometers) is essentially unaffected. FIG. 7D shows a MAP (along the elevational direction or x axis) image, acquired at 584 nm, of a 250-micrometer diameter black needle inserted in a fresh pork specimen. In this case, a penetration depth of approximately 1.6 mm is demonstrated in scattering biological tissue. FIGS. 7E and 7F show photoacoustic MAP and 3D images of a mouse ear microvasculature acquired noninvasively in vivo. Microvessels in diameters down to 30 micrometers are clearly imaged.

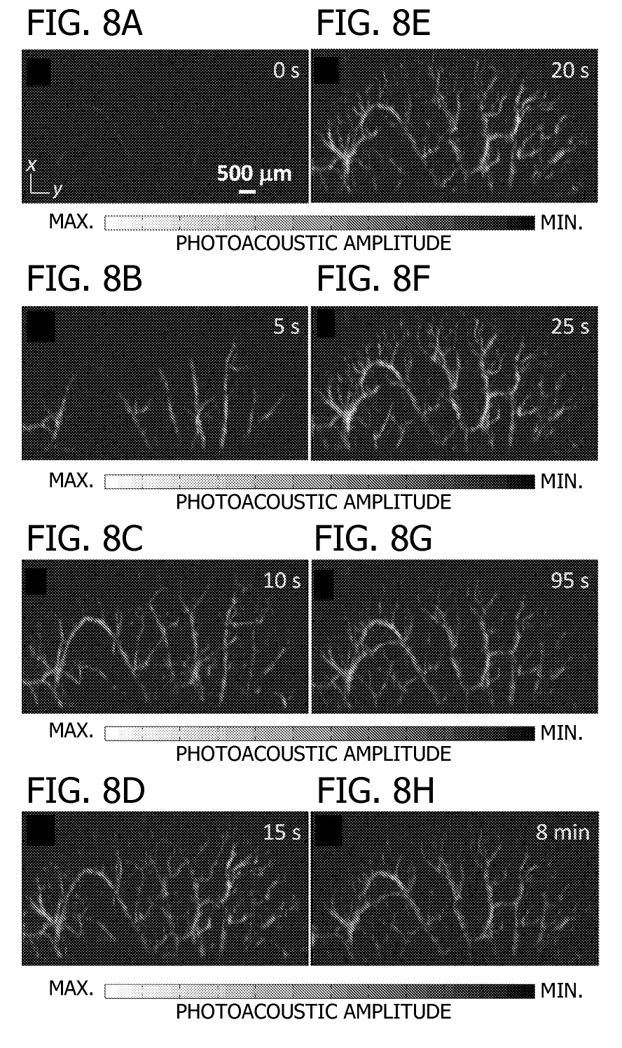

FIG. 8 shows representative frames of real-time in vivo monitoring of the wash-in dynamics of Evans Blue (EB) dye in mouse ear microcirculation. A Swiss Webster mouse weighing approximately 25 g was used. Upon injection of approximately 0.05 ml of 3% EB through the tail vein, the mouse ear was continuously imaged using 600-nm light for up to 2 min at 5-s intervals. At this wavelength, EB has much stronger absorption than hemoglobin, and thus its signal dominates the contrast. It is clearly seen that the dye progressively reaches different levels of vessel branches—from the root to the edge of the ear—at different time points. However, the overall wash-in process is as short as 15-20 s. After 1-2 min, the photoacoustic signal decreases, indicating the beginning of the wash-out of EB.

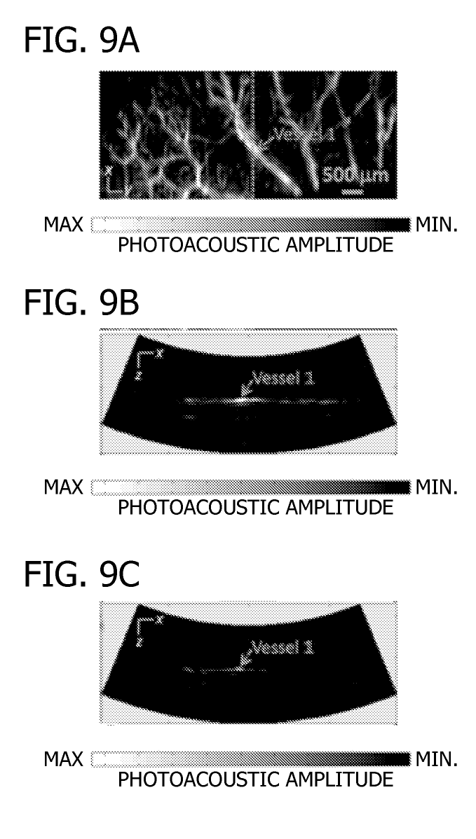

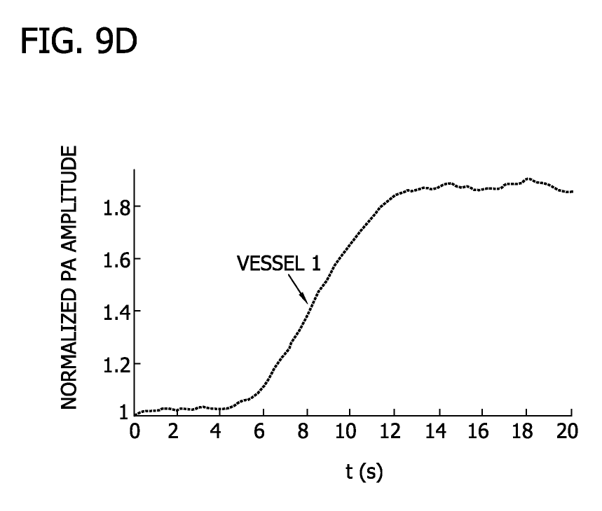

The system prototype permitted distinguishing of arterioles from venules in the microcirculation. In fact, four distinct stages of the wash-in process can be observed in FIG. 8. First EB dye flowed to the major arterioles at the root of the ear. Next, the EB dye reached the arteriole branches and the capillary bed at the edge of the ear. The EB dye then returned to the venule branches from the capillary bed. In the next stage, the EB dye returned to the major venules at the root of the ear. In FIG. 9D, the photoacoustic amplitude representing the EB dye concentration is quantified as a function of time.

With a 50 Hz B-scan imaging rate, substantially the entire EB uptake process was quantitatively imaged by the prototype system. A MAP image and a representative B-scan image of the mouse ear microvasculature acquired at 584 nm are shown in FIGS. 9A and 9B, respectively. The B-scan image in FIG. 9B corresponds to the dotted line in FIG. 9A. FIG. 9C shows a snapshot of a B-scan movie of the EB wash-in dynamics acquired at 600 nm.

With high imaging speed and improved spatial resolution, the preliminary results demonstrate the potential of the present disclosure for broad biomedical applications. For example, imaging speed is one critical issue in advancing photoacoustic endoscopy into clinical practice for early cancer detection or intravascular atherosclerosis imaging. In addition, the high-speed, high-resolution capability will open up new possibilities for the study of diabetes-induced vascular complications, tumor angiogenesis, and pharmacokinetics.

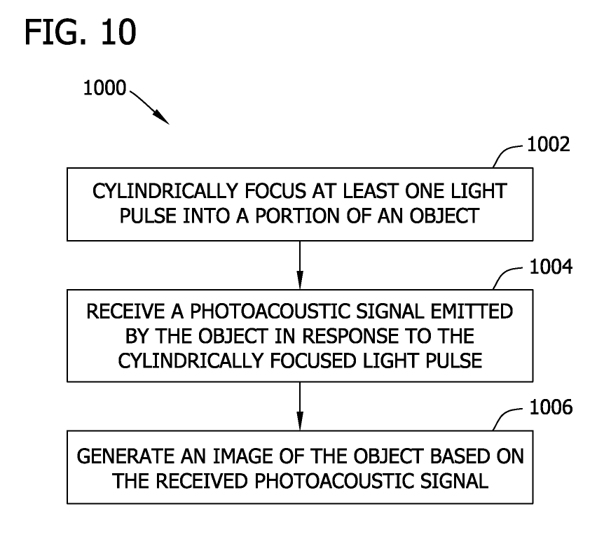

FIG. 10 is a flowchart 1000 that illustrates an exemplary imaging method. In some embodiments, a focusing device, such as cylindrical lens 106, or another suitable focusing device, cylindrically focuses 1002 at least one light pulse into a portion of an object. An ultrasound transducer, such as ultrasound transducer array 113, receives a photoacoustic signal emitted by the object in response to the cylindrically focused light pulse. A computing device, such as a multicore computer, generates an image of the portion of the object based, at least in part, on the received photoacoustic signal.

It will be understood that particular embodiments described herein are shown by way of illustration and not as limitations of the disclosure. The principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations can be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present disclosure have been described in detail, it will be understood by those skilled in the art that various modifications can be made therein without departing from the spirit and scope of the disclosure as set forth in the appended claims.

A controller, computer, or computing device, such as those described herein, includes at least one processor or processing unit and a system memory. The controller typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although the present disclosure is described in connection with an exemplary imaging system environment, embodiments of the disclosure are operational with numerous other general purpose or special purpose imaging system environments or configurations. The imaging system environment is not intended to suggest any limitation as to the scope of use or functionality of any aspect of the disclosure. Moreover, the imaging system environment should not be interpreted as having any dependency or requirement relating to any one or combination of components illustrated in the exemplary operating environment.

Embodiments of the disclosure may be described in the general context of computer-executable instructions, such as program components or modules, executed by one or more computers or other devices. Aspects of the disclosure may be implemented with any number and organization of components or modules. For example, aspects of the disclosure are not limited to the specific computer-executable instructions or the specific components or modules illustrated in the figures and described herein. Alternative embodiments of the disclosure may include different computer-executable instructions or components having more or less functionality than illustrated and described herein.

When introducing elements of aspects of the disclosure or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A probe for use with an imaging system, said probe comprising:
a slit configured to spatially filter a light beam from a light source;
a focusing device configured to cylindrically focus the spatially filtered light beam into an object; and
an ultrasound transducer array configured to detect a photoacoustic signal emitted by the object in response to the cylindrically focused light beam.

2. A probe in accordance with claim 1, wherein said focusing device comprises an objective cylindrical lens.

3. A probe in accordance with claim 2, further comprising an aperture positioned between said slit and said cylindrical lens.

4. A probe in accordance with claim 1, further comprising a condenser cylindrical lens configured to focus the light beam onto the slit.

5. A probe in accordance with claim 1, further comprising a beam combining element configured to permit the light beam to pass through said beam combining element and to direct the photoacoustic signal toward said ultrasound transducer.

6. A probe in accordance with claim 5, further comprising an acoustic lens configured to focus the photoacoustic signal.

7. A probe in accordance with claim 1, further comprising an optically transparent acoustic reflector to direct the photoacoustic signal toward said ultrasound transducer.

8. A probe in accordance with claim 1, further comprising an acoustically transparent optical reflector to direct the light beam toward the object.

9. An imaging system comprising:
a light source configured to emit a light beam; and
a probe comprising:
a slit configured to spatially filter the light beam;
a focusing device configured to cylindrically focus the spatially filtered light beam into an object; and
an ultrasound transducer array configured to detect a photoacoustic signal emitted by the object in response to the cylindrically focused light beam.

10. An imaging system in accordance with claim 9, further comprising a computing device configured to reconstruct an image based on the detected photoacoustic signals.

11. An imaging system in accordance with claim 9, wherein said focusing device comprises an objective cylindrical lens.

12. An imaging system in accordance with claim 11, wherein said probe comprises an aperture positioned between said slit and said cylindrical lens.

13. An imaging system in accordance with claim 9, wherein said light source comprises a tunable laser.

14. An imaging system in accordance with claim 9, wherein said probe comprises a condenser cylindrical lens configured to focus the light beam onto said slit.

15. An imaging system in accordance with claim 9, further comprising an optically transparent acoustic reflector to direct the photoacoustic signal toward said ultrasound transducer.

16. A method for noninvasive imaging, said method comprising:
cylindrically focusing at least one light pulse into a portion of an object;
receiving a photoacoustic signal emitted by the object in response to the cylindrically focused light pulse; and
generating an image of the portion of the object based, at least in part, on the received photoacoustic signal.

17. A method in accordance with claim 16, further comprising filtering the light pulse using a slit prior to cylindrically focusing the light pulse.

18. A method in accordance with claim 16, further comprising focusing the light pulse with a condenser cylindrical lens configured to focus the light pulse onto the slit.

19. A method in accordance with claim 16, wherein said receiving a photoacoustic signal comprises receiving a photoacoustic signal transmitted from the object to a surface of the object on which the light pulse was cylindrically focused.

20. A method in accordance with claim 16, wherein said receiving a photoacoustic signal comprises receiving a photoacoustic signal transmitted from the object to a surface of the object other than that on which the light pulse was cylindrically focused.
